(19) United States
(12) Patent Application Publication
(10) Pub. No.: US 2015/0370971 A1
(43) Pub. Date: Dec. 24, 2015

(54) System and Method for Storing Health Information and Adjudicating Insurance Claims

(71) Applicant: Sheldon G. Weiss, Carmel, IN (US)

(72) Inventor: Sheldon G. Weiss, Carmel, IN (US)

(21) Appl. No.: 14/839,121

(22) Filed: Aug. 28, 2015

Related U.S. Application Data
(62) Division of application No. 13/936,020, filed on Jul. 5, 2013.
(60) Provisional application No. 61/668,218, filed on Jul. 5, 2012.

(51) Int. Cl. G06F 19/00

(52) U.S. Cl. CPC G06F 19/323; G06F 19/328

(57) ABSTRACT

A method of providing healthcare-related services to a patient is provided. The method includes electronically obtaining patient health information stored on a card presented by the patient. The method also includes electronically obtaining patient insurance information stored on the card presented by the patient. The method also includes using the insurance information to contact an insurance carrier to verify that the patient's insurance coverage is active.

### CROSS REFERENCE TO RELATED APPLICATION

This application claims the benefit of and is a divisional of U.S. patent Ser. No. 13/936,020 filed Jul. 5, 2013 and titled “SYSTEM AND METHOD FOR STORING HEALTH INFORMATION AND ADJUDICATING INSURANCE CLAIMS,” which claims the benefit of the disclosure of U.S. Ser. No. 61/668,218, filed Jul. 5, 2012, both of which are incorporated by reference herein.

### TECHNICAL FIELD OF THE INVENTION

The present invention generally relates to systems and methods for administering health information and health insurance and, more particularly, to a system and method for storing health information and adjudicating insurance claims.

### BACKGROUND OF THE INVENTION

More so than in most other commercial transactions, the provision of healthcare-related services (although referred to herein as “services” for convenience of description, the term “healthcare-related services” as used herein is intended to include, without limitation, medical, dental, vision, psychiatric and prescription drug products and/or services) are complicated transactions. This is due to the fact that a third party insurance company is often involved in the transaction for full or partial payment thereof, and due to the fact that the medical records of the patient, while critical to the delivery of such services in a great majority of instances, are subject to restrictive privacy laws, such as those imposed by the U.S. Health Insurance Portability and Accountability Act of 1996 (“HIPAA”; Pub.L. 104-191), to give just one example.

The HIPAA regulations include a Privacy Rule, whose effective date was Apr. 14, 2003. The HIPAA Privacy Rule regulates the use and disclosure of Protected Health Information (PHI) held by “covered entities” (generally, health care clearinghouses, employer sponsored health plans, health insurers, and medical service providers that engage in certain transactions). By regulation, the U.S. Department of Health and Human Services extended the HIPAA Privacy Rule to independent contractors of covered entities who fit within the definition of “business associates”, therefore the HIPAA Privacy Rule applies to most people who are involved in the provision of healthcare-related services. PHI is any information held by a covered entity which concerns health status, provision of health care, or payment for health care that can be linked to an individual. This is interpreted rather broadly and includes any part of an individual's medical record or payment history.

A covered entity may disclose PHI to facilitate treatment, payment, or health care operations without a patient's express written authorization. Any other disclosures of PHI require the covered entity to obtain written authorization from the individual for the disclosure. However, when a covered entity discloses any PHI, it must make a reasonable effort to disclose only the minimum necessary information required to achieve its purpose. It also requires covered entities to take reasonable steps to ensure the confidentiality of communications with individuals.

As a result of the HIPAA Privacy Rule, it can be difficult and time consuming for healthcare providers to share health information related to a particular patient. This is a constant and annoying problem, since in these days of medical specialization, it is not uncommon for a patient to see multiple healthcare providers, and the information obtained (and treatments prescribed) by one provider can represent critical information needed by another provider.

Additionally, there are many emergency situations where the patient's PHI is unavailable, often when the need for it is most critical. For example, Emergency Medical Technicians responding at the scene of an accident, or Emergency Room doctors and nurses treating a patient that has been brought in, may not have access to the most basic information, such as the patient's blood type, allergies and prescription medications currently being taken, and the patient may be unconscious or otherwise unable to provide this critical information.

With respect to the fact that a third party insurance company is often paying for part or all of the healthcare-related services, the financial transaction between the healthcare provider and the patient is complicated. Although it is possible for the healthcare provider to verify that the patient is covered by insurance, the healthcare provider normally does not know what portion of the fee for the healthcare-related services is to be borne by the patient and what portion is to be borne by the insurance company. This normally necessitates the healthcare-related services being provided, the healthcare service provider billing the insurance company, the insurance company adjudicating the claim and communicating to the healthcare service provider what portion of the claim they will reimburse, and then the healthcare service provider invoicing the patient for the remainder. This process is time consuming, both in the amount of time the healthcare provider and their staff must spend shepherding the process for each patient, but also in the delay imposed between provision of the healthcare-related services and reimbursement of the healthcare provider.

It will be appreciated then that there remains a need in the art for improvements in existing systems and methods for providing patient health information and for payment of healthcare-related services. The present invention is directed to satisfying this need.

### SUMMARY OF THE DISCLOSED EMBODIMENTS

Systems and methods are described herein for storing health information and adjudicating insurance claims.

The presently disclosed embodiments provide a medical information card that provides at least two functions. First, the card stores pertinent medical information relating to the person to whom the card was issued. Secondly, the card stores information relating to insurance coverage held by the card owner, with information that will facilitate verification of active coverage, adjudication of insurance claims, and payment for the healthcare-related services. It will be appreciated by those skilled in the art after reviewing the present disclosure that the presently disclosed embodiments could also be used to implement these functions separately rather than collectively, although the invention has particular utility when providing these functions collectively. A variety of methods that may be implemented using the card are also disclosed.

In one embodiment, a medical information card issued to a patient is disclosed, comprising: a card; a memory storage carried by the card, the memory storage containing: health information relating to the patient; and insurance information relating to insurance coverage held by the patient.

In another embodiment, a method of providing healthcare-related services to a patient is disclosed, comprising the steps of: a) electronically obtaining patient health information stored on a card presented by the patient; b) electronically obtaining patient insurance information stored on the card presented by the patient; and c) using the insurance information to contact an insurance carrier to verify that the patient's insurance coverage is active.

In another embodiment, a method of providing healthcare-related services to a patient is disclosed, comprising the steps of: a) electronically obtaining patient insurance information stored on a card presented by the patient; and b) using the insurance information to contact an insurance carrier to receive a binding commitment of what payment the insurance carrier will make for provision of the healthcare-related services.

In another embodiment, a method of providing healthcare-related services to a patient is disclosed, comprising the steps of: a) electronically obtaining patient insurance information stored on a card presented by the patient; and b) using the insurance information to contact an insurance carrier to receive a binding commitment of what payment the insurance carrier will make for provision of the healthcare-related services.

Other embodiments are also disclosed.

### BRIEF DESCRIPTION OF THE DRAWINGS

FIG. 1 is a front plan view of one embodiment card according to the present disclosure.

FIG. 2 is a back plan view of a second embodiment card according to the present disclosure.

FIGS. 3A and 3B are schematic flow diagrams of one embodiment method according to the present disclosure.

FIG. 4 is a schematic flow diagram of a second embodiment method according to the present disclosure.

FIG. 5 is a schematic flow diagram of a third embodiment method according to the present disclosure.

FIG. 6 is a schematic flow diagram of a fourth embodiment method according to the present disclosure.

### DETAILED DESCRIPTION OF THE DISCLOSED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the disclosed and/or illustrated devices and methods, and further applications of the principles of the invention as illustrated therein, as would normally occur to one skilled in the art to which the invention relates are contemplated, are desired to be protected. Such alternative embodiments require certain adaptations to the embodiments discussed herein that would be obvious to those skilled in the art.

The presently disclosed embodiments provide a medical information card that provides at least two functions. First, the card stores and/or provides access to pertinent medical information relating to the person to whom the card was issued. Secondly, the card stores and/or provides access to information relating to insurance coverage held by the card owner, with information that will facilitate verification of active coverage, adjudication of insurance claims, and payment for all or a portion of the healthcare-related services. It will be appreciated by those skilled in the art after reviewing the present disclosure that the presently disclosed embodiments could also be used to implement these functions separately rather than collectively, although the invention has particular utility when providing these functions collectively. A variety of methods that may be implemented using the card are also disclosed.

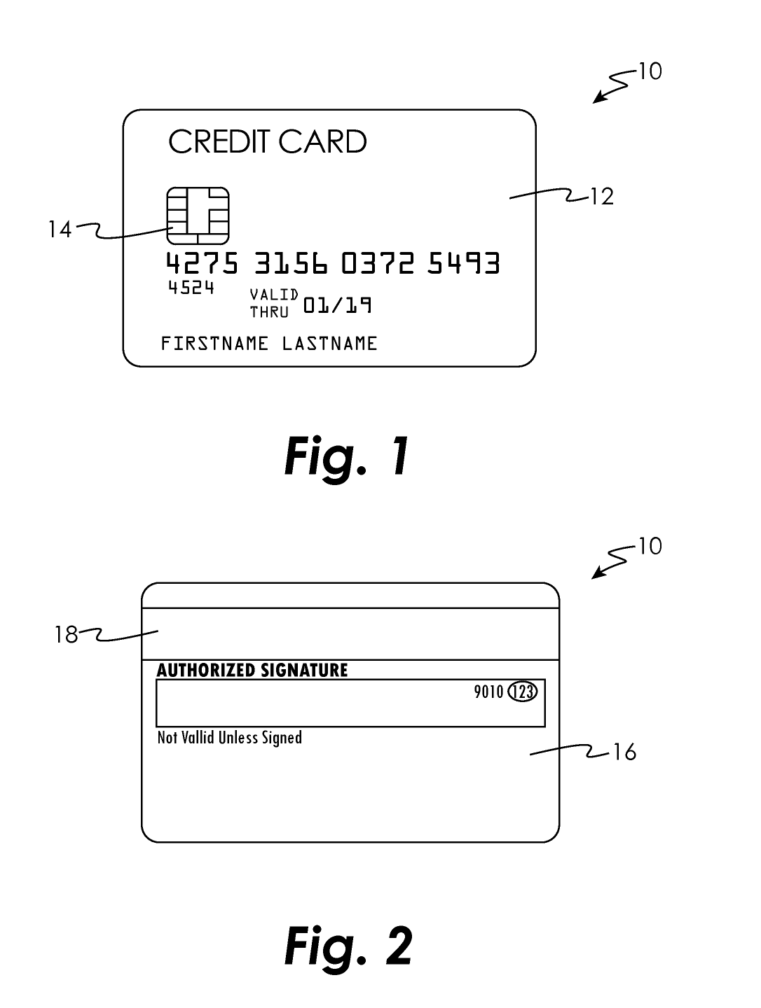

A first embodiment device is illustrated in FIG. 1 and indicated generally at 10. The device comprises an identification card, which also may be a payment card, such as a credit card, debit card, Health Savings Account (HSA) payment card or Flexible Spending Account (FSA) payment card, to name just a few non-limiting examples. FIG. 1 illustrates a front side 12 of the card 10. In some embodiments of the card 10, the card 10 is a so-called smart card, chip card, integrated circuit card (ICC), or any other type of card with embedded integrated circuits. The card 10 carries embedded circuitry which includes an electronic memory device. In some embodiments, the card 10 is a contact smart card in which the electronic memory device may be accessed via contact pads 14 on the face 12 of the card 10. Contact smart cards have a contact area of approximately 1 square centimeter (0.16 square inch), comprising several gold-plated contact pads 14. These pads provide electrical connectivity when inserted into a reader, which is used as a communications medium between the smart card 10 and a host (e.g., a computer, a point of sale terminal, or a mobile telephone, to name just a few non-limiting examples). In some embodiments, the contact smart card 10 conforms to the ISO/IEC 7810 and ISO/IEC 7816 series of standards. In other embodiments, the contacts 14 are located elsewhere on the card 10. When the card 10 is inserted into a suitable reader (not shown), contacts (not shown) are brought into contact with the contact pads 14 and information may be stored to, and/or read from, the electronic memory device on the card 10. In the embodiments disclosed herein, the card 10 reader is operatively coupled to a computer system of a healthcare provider.

The smart card 10 does not require an internal power supply. Instead, it draws its power from the reader through the contacts pads 14. Such smart cards 10 lend themselves to use with sensitive PHI because they contain a tamper-resistant security system (for example a secure cryptoprocessor and a secure file system) and provide security services (e.g., they protect in-memory information). Interchange of information to and from the card 10 is managed by an administration system which securely interchanges information and configuration settings with the card, controlling card blacklisting and application-data updates, as is known in the art.

Alternatively, the card 10 may be a contactless smart card, in which the card communicates with and is powered by the reader (not shown) through radio frequency (RF) induction technology (currently at data rates of 106-848 kbit/s). Cards according to this embodiment require only proximity to an antenna to communicate Like smart cards 10 with contact pads 14, contactless smart cards do not have an internal power source. Instead, they use an inductor to capture some of the incident radio-frequency interrogation signal, rectify it, and use it to power the card's electronics. Application Protocol Data Unit (APDU) transmission via a contactless interface is defined in the ISO/IEC 14443-4 standard.

FIG. 2 illustrates a back side 16 of the card 10. In some embodiments of the card 10, the card 10 carries data recording layer, such as the magnetic stripe 18 shown on the back side 16. In other embodiments, the magnetic stripe 18 is located elsewhere on the card 10. A magnetic stripe card is a type of card capable of storing data by modifying the magnetism of tiny iron-based magnetic particles on the band of magnetic material 18 on the card. When the card 10 is inserted into, or swiped through, a suitable reader (not shown), electromagnetic read/write heads (not shown) are brought into contact with the magnetic stripe 18 and information may be stored to, and/or read from, the magnetic stripe 18 on the card 10.

It will be appreciated that other types of memory storage devices besides the electronic memory device and magnetic stripe of the card 10 may be used in other embodiments. The particular type of technology used to store information on the card 10 is not critical.

In some embodiments, the memory storage device on the card 10 is used to store patient health information relating to the owner of the card 10. By way of non-limiting example, the memory storage device may include one or more of the following pieces of information:

1. patient name

2. blood type

3. known allergies

4. medications taken

5. past medical history

6. past surgical history

7. physicians seen/hospitals visited during a prior period of time

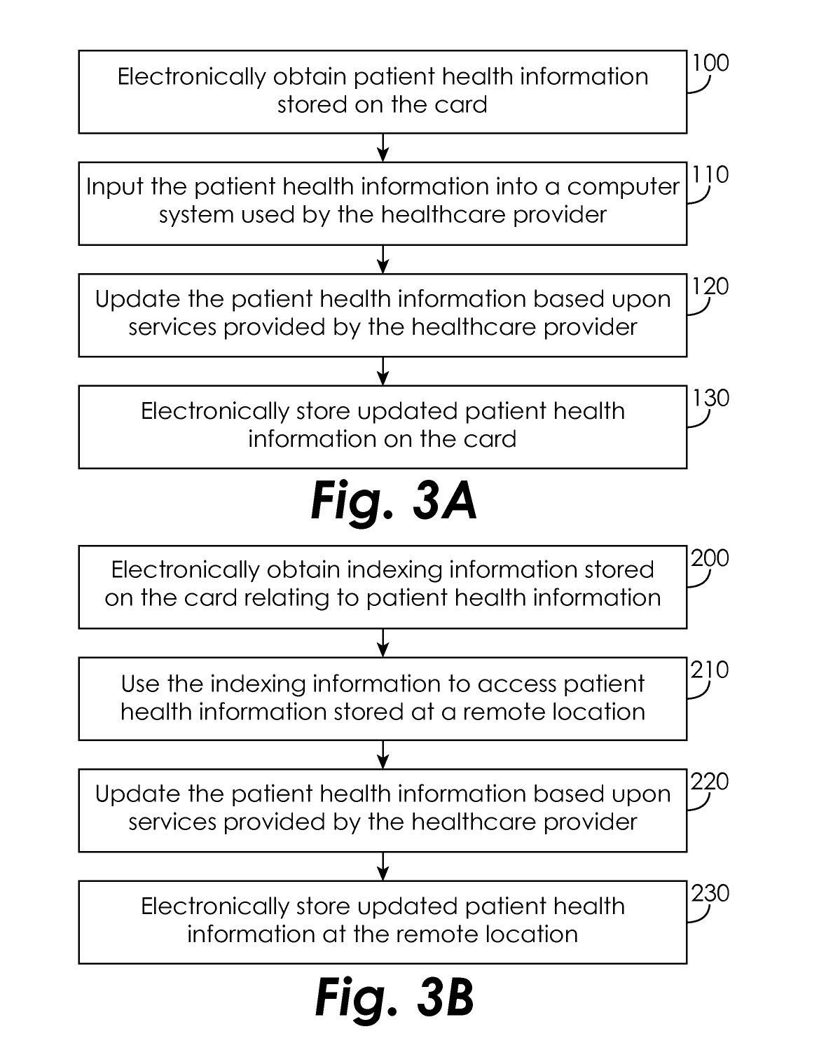

As indicated in FIG. 3A, the patient health information may be stored directly in the memory storage device on the card 10. When the healthcare provider inserts, swipes, scans, or otherwise reads the card 10, the patient health information is electronically obtained (step 100) from the memory storage device and input into a computer system used by the healthcare provider (step 110). After healthcare services are provided to the patient, the healthcare provider updates the patient health information (step 120) and electronically stores the updated patient health information on the card (step 130).

Alternatively as shown in FIG. 3B, because of space limitations and/or data security concerns, the memory storage device on the card 10 may instead record information that will allow the healthcare provider reading the card to access the patient health information stored at a remote location, such as in so-called cloud storage accessed via the internet. By way of non-limiting example, the memory storage device on the card 10 may include an internet URL at which the patient health information is available. In some embodiments, the memory storage device on the card 10 includes information needed to access the patient health information from the site addressed by the internet URL, such as patient name and/or identification number and password, to name just a few non-limiting examples. In other embodiments, the card reader and/or the healthcare service provider's computer system knows where patient health information is remotely stored, and the card 10 only stores patient identifying information, or patient identifying information and a password (or other security information) that allows access to the patient health information.

When the healthcare provider inserts, swipes, scans, or otherwise reads the card 10, the computer system used by the healthcare provider electronically obtains from the card 10 indexing information stored on the card that allows access to patient health information electronically stored somewhere besides the card 10 (step 200). The healthcare provider's computer uses the indexing information to access remotely stored patient identification information, and optionally a password or other security information is provided to the remote storage location to verify that the healthcare provider is entitled to access the information, and the patient health information is downloaded from remote storage location and into the computer system used by the healthcare provider (step 210). Ancillary clinical information pertaining to the patient, such as laboratory tests and X-rays to name just two non-limiting examples, can also be stored in this way for future use by healthcare providers as needed. After healthcare services are provided to the patient, the healthcare provider updates the patient health information (step 220) and electronically stores the updated patient health information at the remote storage location (step 230).

In this way, the healthcare provider can easily obtain the patient health information and be sure that the most up-to-date and complete information is being obtained. This can represent a substantial improvement over current practice. In some situations, the patient is forgetful and does not remember information that the healthcare provider would consider to be important for treating the patient. In an emergency situation, the patient may be unconscious or otherwise unable to provide such information. In any circumstance, the healthcare provider will be able to access such information much more quickly than if it was obtained from the patient either orally or in writing. Additionally, since the patient health information is being relayed to the healthcare provider electronically, it may easily be stored in the computer system of the healthcare provider and automatically populated into databases and/or software being executed by the computer system. Not only does this save the time and expense of manual data entry by the healthcare provider's staff, it eliminates transcription errors and ensures that the data is immediately available for review by the healthcare provider, in the format in which the healthcare provider desires to view it.

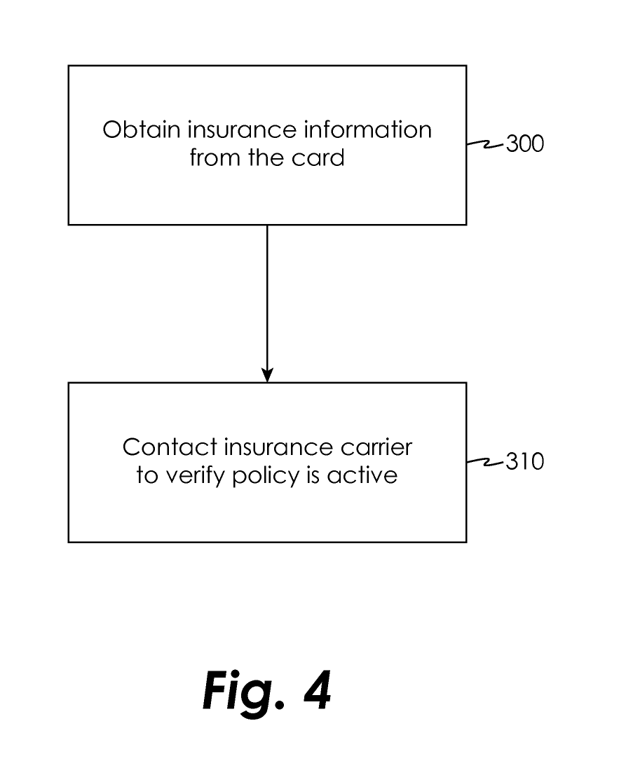

As briefly discussed hereinabove, the memory storage device on the card 10 may also store insurance information related to an insurance policy under which the patient may be entitled to benefits. In one embodiment, the insurance information may comprise the identity of the insurance carrier and the policy number. As shown in FIG. 4, in one embodiment method, the insurance information is obtained from the card 10 by the healthcare provider computer system at step 300. At step 310, the healthcare provider computer system contacts the insurance carrier to verify that the patient's insurance coverage is still active. Alternatively, the healthcare provider may manually verify that the insurance coverage is active, such as by telephoning the insurance carrier.

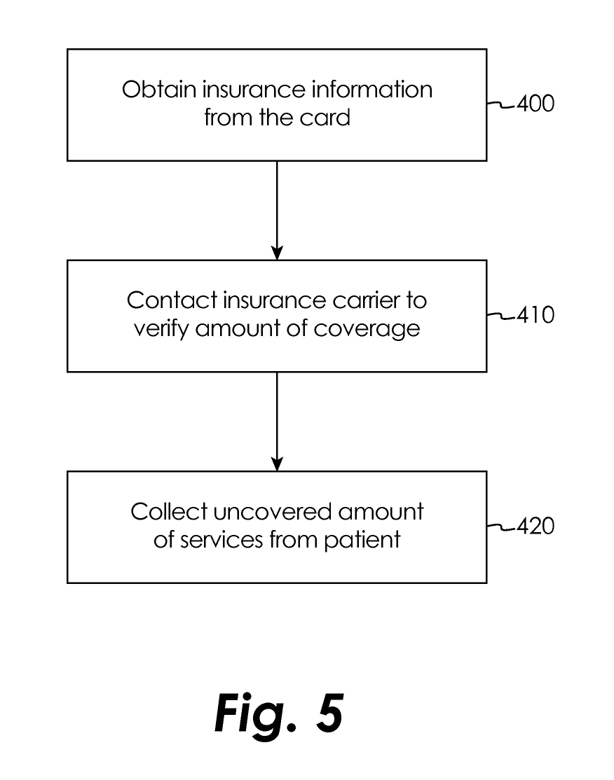

As illustrated in FIG. 5, the insurance information obtained from the card 10 may also be used to determine what portion of the healthcare provider's fee will likely be the responsibility of the insurance carrier and what portion will likely be the responsibility of the patient. For example, the insurance policy may indicate that the patient is responsible for a “copay” amount of 20% of the first $5,000 in covered healthcare charges during any policy year. Alternatively, the patient may have a deductible amount that has not yet been met for the policy year, wherein the insurance carrier does not begin to provide benefits until after the deductible has been exceeded. In another alternative, the patient may be responsible for a fixed dollar copay for each office visit to the healthcare provider.

Therefore, in one embodiment method, the insurance information is obtained from the card 10 by the healthcare provider computer system at step 400. At step 410, the healthcare provider computer system contacts the insurance carrier to verify what portion of the healthcare provider's fee the patient's insurance coverage will cover if the healthcare provider's invoice is accepted by the insurance carrier. In prior art insurance systems, if the healthcare provider contacts the insurance carrier to question whether a procedure is covered, the insurance carrier states that the procedure is a covered service but payment is not guaranteed until a claim is submitted and coverage is reconfirmed. Therefore, the healthcare provider is not sure of the outcome at the time that the treatment is performed. With the presently disclosed embodiments, the insurance carrier is confirming that coverage is active at the exact time the services are to be rendered and is confirming to the healthcare provider what payment will be made for the services. In other words it is binding, unlike prior art systems and methods.

Alternatively, the healthcare provider may manually verify the insurance coverage, such as by telephoning the insurance carrier. At step 420, the healthcare provider collects from the patient the amount of the healthcare provider's fee that is not anticipated to be paid by the insurance carrier. In this way, the healthcare provider may collect the portion of the fee that is the patient's responsibility while the patient is still in the healthcare provider's office. This increases the odds that the healthcare provider will actually receive the portion of the fee that is the patient's responsibility, and eliminates the expense and delay involved in invoicing the patient at a later time. In some embodiments, the healthcare provider may collect the portion of the fee that is the patient's responsibility prior to providing the services.

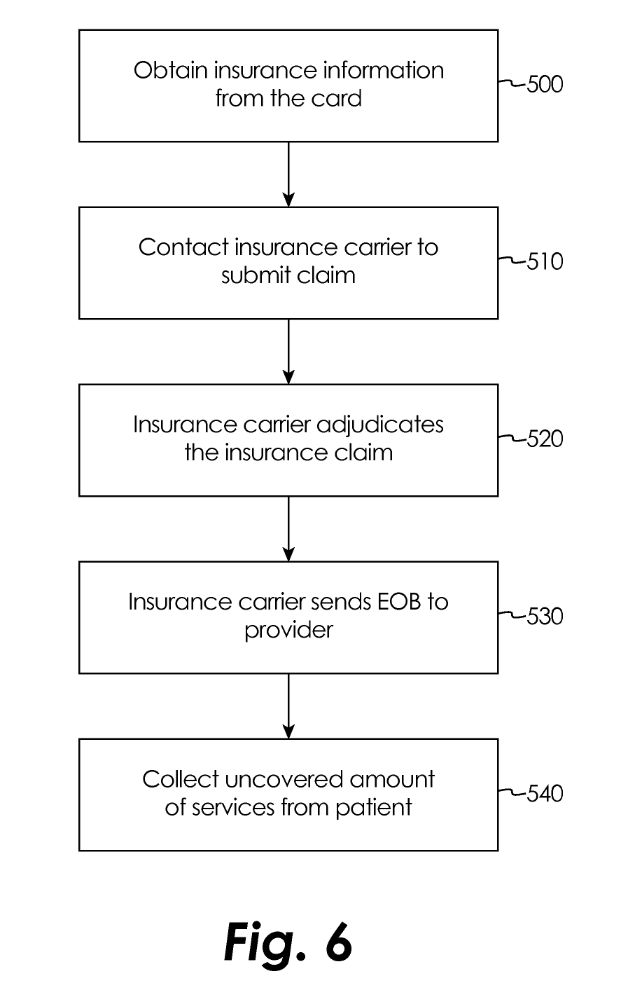

In another embodiment, the healthcare provider's fee for services is actually adjudicated by the insurance carrier while the patient is at the healthcare provider's office. As illustrated in FIG. 6, the insurance information obtained from the card 10 may be used to allow the insurance carrier to adjudicate the healthcare provider's service fee claim in order to determine what portion of the healthcare provider's fee will be the responsibility of the insurance carrier and what portion will be the responsibility of the patient. In one embodiment method, the insurance information is obtained from the card 10 by the healthcare provider computer system at step 500. At step 510, the healthcare provider computer system contacts the insurance carrier to submit the healthcare provider's fee for services as a claim for adjudication. In some embodiments, this is done as a “test run” prior to actually providing the service so that the healthcare provider and the patient will know what the insurance carrier will pay for. This step may also be used to determine if a precertification is required by the insurance carrier. At step 520, the insurance carrier adjudicates the claim to determine what portion of the healthcare provider's fee the patient's insurance policy will pay, and what portion of the healthcare provider's fee the patient will be responsible for. Alternatively, the healthcare provider may manually verify the insurance coverage, such as by telephoning the insurance carrier. At step 530, the insurance carrier send an explanation of benefits (EOB) to the healthcare provider detailing the results of the adjudication. At step 540, the healthcare provider collects from the patient the amount of the healthcare provider's fee that is not covered by the insurance carrier. In this way, as with the embodiment of FIG. 4, the healthcare provider may collect the portion of the fee that is the patient's responsibility while the patient is still in the healthcare provider's office. This increases the odds that the healthcare provider will actually receive the portion of the fee that is the patient's responsibility, and eliminates the expense and delay involved in invoicing the patient at a later time. In some embodiments, the healthcare provider may request an adjudication of the insurance claim and/or collect the portion of the fee that is the patient's responsibility prior to providing the services.

The International Classification of Diseases (most commonly known by the abbreviation ICD) published by the United Nations-sponsored World Health Organization is a healthcare classification system that provides codes to classify diseases and a wide variety of signs, symptoms, abnormal findings, complaints, social circumstances, and external causes of injury or disease. Under this system, every health condition can be assigned to a unique category and given a code, up to six characters long. Such categories can include a set of similar diseases. The ICD is revised periodically and is currently in its tenth edition. The ICD-10, as it is therefore known, is currently in use along with ICD-9. While the ICD codes are diagnostic codes, the Current Procedural Terminology (CPT) is a similar code set for procedure codes maintained by the American Medical Association through the CPT Editorial Panel. In some embodiments, the healthcare provider provides the proper ICD-9 or ICD-10 diagnostic codes and the CPT procedure code and the system makes sure the code has not been used in the past for this patient and, if it has been used in the past, defaults for reconfirmation from the healthcare provider to confirm proper coding before sending the charge to insurance carrier. For example, if the code for gall bladder removal has been previously used for this patient, the system would not expect the same code to be used again for the patient. The system also checks to make sure that the ICD code and the CPT code appear to relate to the same condition. This helps to protect against duplicate billing, fraudulent or accidental, saving the healthcare providers penalties, etc.

In some embodiments, if a code for an infectious condition is entered, the system checks the patient's medical records to check the patient's allergy status and sends a message back to the healthcare provider to confirm that the patient is not allergic to anything that is being prescribed. This process also applies to all other codes that are pertinent to different disease processes.

After the healthcare provider has performed the healthcare services, a record of those services is added to the patient health information that may be accessed using the card 10. For example, the reader that is used to interface between the card 10 and the healthcare provider's computer system may record this information directly to the memory storage device carried by the card 10. In other embodiments, this information is provided to the website from where the healthcare provider obtained the prior patient health information so that the database of health information maintained therein may be made up-to-date. In this way, the next time that the patient's health information is accessed using the card 10, the patient health information will include the services rendered by the current healthcare provider.

In some embodiments, the card 10 is also a payment card, and may be used to transfer funds to the healthcare provider for the portion of the healthcare provider's services that are the responsibility of the patient. By way of non-limiting example, the card 10 may be a payment card, such as a credit card, debit card, Health Savings Account (HSA) payment card or Flexible Spending Account (FSA) payment card, or any other type of card that is operative to cause payment to be made to the healthcare provider for the portion of the healthcare services that are the responsibility of the patient. In these embodiments, the computer system used by the healthcare provider is operative to utilize the card 10 to cause payment to be made to the healthcare provider for the portion of the healthcare services that are the responsibility of the patient. Therefore, in either of the steps 420 or 540 discussed above, the amount of the healthcare provider service fee that is not covered by the insurance carrier may be collected by initiating payment (such as by an electronic funds transfer) to the healthcare provider from the payment facility linked to the card 10.

For example, when the card 10 is a credit card, it is used by the computer system of the healthcare provider to initiate payment (such as by an electronic funds transfer) to the healthcare provider from the credit provider. When the card 10 is a debit card, it is used by the computer system of the healthcare provider to initiate payment (such as by an electronic funds transfer) to the healthcare provider from the patient's bank account linked to the debit card. When the card 10 is a Health Savings Account (HSA) payment card, it is used by the computer system of the healthcare provider to initiate payment (such as by an electronic funds transfer) to the healthcare provider from the patient's Health Savings Account linked to the payment card. When the card 10 is a Flexible Spending Account (FSA) payment card, it is used by the computer system of the healthcare provider to initiate payment (such as by an electronic funds transfer) to the healthcare provider from the patient's Flexible Spending Account linked to the payment card. In some embodiments, the card 10 is not used to pay the portion of the fee for which the patient is responsible. Instead, the patient makes payment by separate means.

Use of the card 10 has other benefits as well. For example, the card 10, when used in conjunction with Medicare, Medicaid or other insurance types, may eliminate known schemes of fraudulent charges by healthcare providers, such as schemes where a patient visits the healthcare provider once and then the healthcare provider “phantom bills” the insurance carrier every week thereafter even though the patient has not returned to see the healthcare provider. If the card 10 is required by the computer system to be present in the reader in order for the methods disclosed herein to be functional, then the patient must be at the healthcare provider's office for an invoice to be submitted to the insurance carrier. This prevents the healthcare provider from being able to submit insurance claims merely by knowing the patient's insurance policy information, since physical possession of the card 10 is required at the time of submitting the claim.

The card 10 provides a benefit to the healthcare provider in that the provider receives payment from both the insurance carrier and the patient much more quickly than is presently the case, and without having to send an invoice to the patient. The systems and methods disclosed herein are a benefit to the insurance carrier and the patient, in that they ensure that the healthcare provider receives the most complete and up-to-date patient health information available, increasing the likelihood of a successful treatment. This lowers the cost for both the insurance carrier and the patient since potential future medical treatment associated with less-than-optimal current treatment is avoided. The obvious benefit to the patient is that the patient receives more effective treatment.

In some embodiments, the card 10 is offered to patients free of charge. The cost to implement and use the card 10 may be offset by the electronic funds transfer fees charged by the issuers of the cards.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. Specifically, various steps in disclosed sequences may be executed in different orders than specified in the disclosed embodiments.

What is claimed:

1. A method of providing healthcare-related services to a patient, the method comprising:
electronically obtaining patient health information stored on a card presented by the patient;
electronically obtaining patient insurance information stored on the card presented by the patient; and
using the insurance information to contact an insurance carrier to verify that the patient's insurance coverage is active.

2. The method of claim 1 further comprising using the card presented by the patient as a payment card.

3. The method of claim 2 further comprising using the card presented by the patient to facilitate electronic funds transfers from an account selected from the group consisting of: credit card account, debit card account, Health Savings Account, and Flexible Spending Account.

4. The method of claim 2 further comprising using radio frequency induction technology to use the card presented by the patient as a payment card.

5. The method of claim 2 further comprising using a magnetic stripe to use the card presented by the patient as a payment card.

6. The method of claim 1 further comprising electronically obtaining patient health information selected from the group consisting of: patient's name, patient's blood type, patient's known allergies, medications taken by the patient, patient's past medical history, patient's past surgical history, physicians seen by the patient during a prior period of time, hospitals visited by the patient during the prior period of time, and indexing information enabling access to medical information of the patient stored elsewhere.

7. The method of claim 6 further comprising obtaining patient health information using a uniform resource locator (URL) and login information needed to access health information of the patient through a website addressed by the URL.

8. The method of claim 1 further comprising electronically obtaining patient health information selected from the group consisting of: prior laboratory test results of the patient, and prior X-ray data of the patient.

9. The method of claim 1 further comprising electronically obtaining patient insurance information selected from the group consisting of: identity of an insurance carrier providing insurance to the patient, and a policy number.
